(19) United States
(12) Patent Application Publication
(10) Pub. No.: US 2020/0090055 A1
(43) Pub. Date: Mar. 19, 2020

(54) DATA RETRIEVAL WITH BIAS REDUCTION

(71) Applicant: salesforce.com, Inc., San Francisco, CA (US)

(72) Inventor: Daniel Thomas Harrison, San Francisco, CA (US)

(21) Appl. No.: 16/136,230

(22) Filed: Sep. 19, 2018

(51) Int. Cl. G06N 5/04

(52) U.S. Cl. CPC G06N 5/04

(57) ABSTRACT

Digital data systems and methods support data retrieval with bias reduction. In some embodiments, these minimize the effect of bias in artificial intelligence-based business intelligence engines by preventing reporting of models that are based on “bias-sensitive” predictor variables such as race, sex and political affiliation, and so forth. In other embodiments, e.g., where the AI engine returns measures (or degrees) of correlation, such censure can be with respect to models where those measures are above a designated quantitative or qualitative high water mark values. Alternatively, or in addition, the systems and methods hereof can minimize the effect of data bias by reducing such a measure of correlation so that the corresponding model appears inferior to ones that are not based on bias-sensitive predictor variables.

### BACKGROUND

The rise of online retailing, has fueled growth of data sets reflecting user activities and preferences. In the past, retailers might have been content to use those data sets, in bulk, to drive mass email, SMS text, web browser banner, as well as web content-based campaigns. With large data sets, this can be resource-prohibitive and, in any event, ineffective since recipients may be numbed into ignoring mailings to which they might otherwise best respond.

Business intelligence engines can overcome this by using artificial intelligence and/or other techniques to retrieve from large data sets information on users best targeted for an upcoming advertising campaign or other goal. Once such use of business intelligence, for example, is to identify correlations among and between fields in a data set. For example, a business intelligence engine analysis of a general retailer data set might identify a correlation between orders for graduation announcement cards and those for sunglasses. Some such correlations properly represent the user population being estimated, Some do not: they reflect data bias.

The prior art has failed to address this adequately. Mailings driven by traditional business intelligence engines often perpetuate biases of the data sets that drive them to the detriment of the business and potential customers alike.

### BRIEF DESCRIPTION OF THE DRAWINGS

A more complete understanding may be attained by reference to the drawings, in which:

FIG. 1 depicts a digital data processing system 10 for data retrieval with bias reduction; and,

FIG. 2 depicts a method of operation of the system of FIG. 1 for data retrieval with bias reduction.

### DETAILED DESCRIPTION OF THE ILLUSTRATED EMBODIMENT

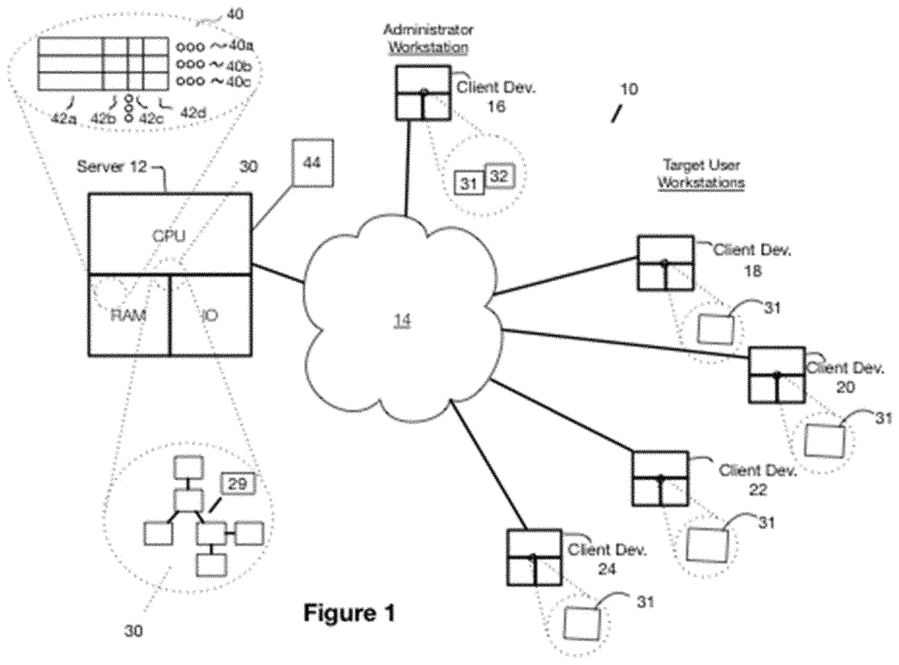

FIG. 1 depicts a digital data processing system 10 for data retrieval with bias reduction.

The illustrated system 10 includes a server digital data device 12 that is coupled via network 14 for communication with one or more client digital data devices 16-24. The digital data devices 12 and 16-24 comprise conventional desktop computers, workstations, minicomputers, laptop computers, tablet computers, PDAs or other digital data devices of the type that are commercially available in the marketplace, all as adapted in accord with the teachings hereof. For example, the devices 12 and 16-24 each comprise central processing (CPU), memory (RAM), and input/output (TO) subsections of the type conventional in the art, as adapted in accord with the teachings hereof.

Devices 12 and 16-24 (and, more particularly, for example, their respective CPU, RAM and TO subsections) are configured to execute software such as operating systems, a web server 29 (in the case of device 12), web browsers and/or web apps 31 (in the case of devices 16-24) and otherwise—all of the conventional type known in the art as adapted in accord with the teachings hereof.

Device 12 additionally executes a business intelligence engine and, more particularly, an artificial intelligence engine 30 that generates predictive models from a data set 40 reflecting customer or other data regarding individuals. Such a data set 40 can, e.g., be of the type contained in a data store local to or disposed remotely from server 12 (e.g., in the “cloud”), all per convention in the art as adapted in accord with the teachings hereof. The data set 40, shown here by way of non-limiting example residing in memory (RAM) of server 12, comprises a set of data records 40a-40c each representing an individual and comprising values for a plurality of fields 42a-42d, each pertaining to a characteristic of that individual. An exemplary such data set 40 can include, for example, records each reflecting demographic information regarding a respective customer or client of an enterprise, as well as that individual's purchasing or other business history with the enterprise. Such a data set 40 can include other information, instead or in addition, again, per convention in the art. For example, in some embodiments, the data set 40 can include data pertaining to the gender, age, religion, educational background, email address(es) and order information for each customer or other individual. Moreover, although, a single data set 40 is shown here, in practice, the data set may comprise data from multiple sources, themselves, local or remote to server 12.

Construction and updating of data sets 40 can be per convention in the art, as adapted in accord with the teachings hereof. Although three records 40a-40c and four fields 42a-42d are shown in the drawing, it will be appreciated that this is by way of example and that the numbers of records and/or fields in other data sets 40 may vary from that shown here.

The predictive model (not shown) generated by engine 30 from data set 40 identifies one or more of fields 42a-42d of the data set 40 as predictor variables that are correlated with a field of that data set designated (by an administrator, operator or otherwise) as a target variable. By way of non-limiting example, such a model can identify age, zip code and date-of-most-recent-purchase fields of a data set 40 as predictor variables that are correlated with a likely-to-purchase-within-the-next-30-days field designated by an operator as a target variable.

In the illustrated embodiment, the predictive model is likely to identify not just fields of the data set 40 as predictor variables that are correlated with the target variable but, rather, values or sets of values of those fields. Continuing the prior example, a predictive model generated by the engine 30 from data set 40 can identify values for the fields: age (in the range of 28-40 years old), zip code (equal to 90201), and date-of-most-recent-purchase (within the last six months) as predictor variables correlated with a likely-to-purchase-within-the-next-30-days field. Regardless of whether the model identifies fields or field values as predictor variables, these are referred to as “fields” for sake of simplicity herein.

In some embodiments, the predictive model generated by the engine 30 not only identifies predictor variables that are correlated with the target variable but also provides a qualitative measure of the degree of correlation between each predictor variable and the target variable, e.g., highly, moderately, weakly and so forth, while still other embodiments provide a quantitative measure of that degree of correlation, e.g., 95%, 70% and so forth. The engine can, instead or in addition, identify with the predictive model the degree of correlation between the model itself (i.e., the predictor variables that make up the model and the respective weighting or other factors associated with those variables) and the target variable. The generation and representation of such predictive models (including identification of the predictor variables and degrees of correlation) is within the ken of those skilled in the art in view of the teachings hereof.

As used herein, the terms “correlated with” (and “the like”) refer to a predictor variable (or variables) that have a designated degree of correlation with a target variable. In some embodiments, for example, predictor variable(s) are considered to be correlated with a target variable if the degree of correlation is high (or strong) or moderate, while in other embodiments only variables that are highly (or strongly) correlated with a target variable are considered to be “correlated with” that variable. In still other embodiments, predictor variable(s) are considered to be correlated with a target variable only if a quantitative degree of correlation is above a certain value, e.g., 60%.

Invocation and control of the engine 30 by an administrator or other operator, as well as reporting of predictive models thereto, can be via web server 29 and the browser/app 31 of a client device—in the illustrated embodiment, client device 16—in communications therewith, per convention in the art as adapted in accord with the teachings hereof. Thus, for example, the browser and/or app 31 of device 16 can be configured and/or utilized, e.g., by an administrator or otherwise, in the conventional manner in the art as adapted in accord with the teachings hereof, to invoke the artificial intelligence engine 30 for purposes of generating a predictive model as described above. This can include specifying target and potential predictor variables, data set(s) 40 to be used in connection with model generation, as well as specifying, portions of that (or other) data set(s) to be used in training and testing portions of such model generation, as applicable, all per convention in the art as adapted in accord with the teachings hereof.

In the illustrated embodiment, the browser/app 31 of client device 16, i.e., that utilized by the aforesaid administrator or other operator of that device (hereinafter, simply, “administrator”) includes additional software 32 that identifies bias in predictive models generated by engine 30 to prevent or alter their reporting to the administer. The bias identification software, which may be implemented as a plug-in or other extension to browser/app 31 or a stand-alone that operates in co-operation therewith, is referred to herein as “app” 32 and is coupled directly, indirectly or otherwise to a table, database or other store 44 that identifies fields of data set 40 that are or may be “bias-sensitive”—that is, fields whose values actually or potentially suffer data bias or that may be perceived as such. Examples include fields containing customer (or other individual) gender, religion or age.

The store 44 may be maintained locally to the device 16, locally to the server 12 or otherwise (e.g., in the “cloud”). Access to it for purposes of creating, reading, updating and deleting entries by app 32, engine 30 or otherwise, is within the ken of those skilled in the art in view of the teachings hereof. The store 44 is initially populated by the administrator, e.g., via a text editor, spreadsheet program or other software to enter names or other identities of “bias-sensitive” fields into the store 44, by importing them via drag-and-drop, CSV (comma-delimited) file, or otherwise. The store 44 may subsequently be updated, e.g., by the app 32 if and as it identifies additional fields in the data set 40 that are highly correlated with those previously identified (e.g., by the administrator) as bias-sensitive, which additional fields can, themselves, be identified as bias-sensitive, automatically, at the upon confirmation of the administrator or otherwise.

Models generated by the engine 30 can, moreover, be communicated to and/or otherwise used to target electronic mail (email), SMS text, web browser banner, as well as web content-based, mailing label-printing campaigns or other processes and/or apparatus for purposes of sending marketing or other information, in electronic, paper or other forms, e.g., to workstations 18-24, of individuals whose characteristics, as reflected in values of the data set 40 or otherwise, fall within the scope of predictor variables identified in the model. By way of non-limiting example, in some embodiments, models generated by the engine 30 are used to drive email marketing campaigns to selected ones of client devices 18-24, all per convention in the art as adapted in accord with the teachings hereof.

Network 14 comprises one or more networks suitable for supporting communications between server 12 and data devices 16-24. The network comprises one or more arrangements of the type known in the art, e.g., local area networks (LANs), wide area networks (WANs), metropolitan area networks (MANs), and or Internet(s).

Although only a single server digital data device 12 is depicted and described here, it will be appreciated that other embodiments may utilize a greater number of these devices, homogeneous, heterogeneous or otherwise, networked or otherwise, to perform the functions ascribed hereinto web server 29, engine 30 and/or digital data processor 12. Likewise, although several client digital data devices 16-24 are shown, it will be appreciated that other embodiments may utilize a greater or lesser number of these devices, homogeneous, heterogeneous or otherwise, running applications 31 that are, themselves, homogeneous, heterogeneous or otherwise. Moreover, one or more of server devices 12 may be configured as and/or to provide a database system (including, for example, a multi-tenant database system) or other system or environment. And, although shown here in a client-server architecture, the devices 12 and 16-24 may be arranged to interrelate in a peer-to-peer, client-server or other protocols and architectures consistent with the teachings hereof.

As those skilled in the art will appreciate the “software” referred to herein—including, by way of non-limiting example, web server 29, web browsers/apps 31 and artificial intelligence engine 30—comprise computer programs (i.e., sets of computer instructions) stored on transitory and non-transitory machine-readable media of the type known in the art as adapted in accord with the teachings hereof, which computer programs cause the respective devices to perform the respective operations and functions attributed thereto herein. Such machine-readable media can include, by way of non-limiting example, hard drives, solid state drives, and so forth, coupled to the respective digital data devices in the conventional manner known in the art as adapted in accord with the teachings hereof.

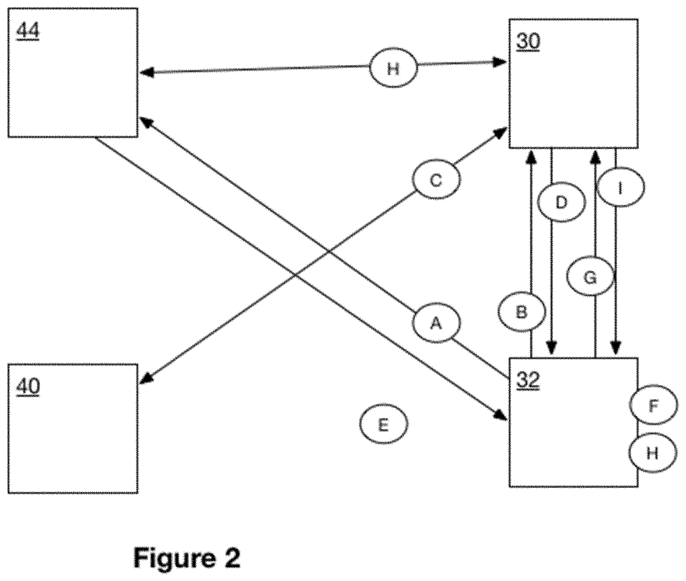

A method of operating the system of FIG. 1 is shown in FIG. 2, in which like designations are used to denote like elements.

In step A, the store 44 is populated with names or other identities of bias-sensitive fields, e.g., “gender,” “age,” “religion,” and so forth. This may be by the administrator of device 16, e.g., using a text editor, spreadsheet, drag-and-drop, file import or other interface of app 32 and/or of other software executing on device 12 and/or in conjunction therewith, and the bias-sensitive fields may be selected by the administrator/operator in any manner appropriate to the circumstance(s) in which system 10 will be used. The store 44 may subsequently updated in like manner or otherwise (e.g., by the app 32 if and as it identifies additional fields in the data set 40 that are highly correlated with those previously identified (e.g., by the administrator) as bias-sensitive, which additional fields can, themselves, be identified as bias-sensitive, automatically, at the upon confirmation of the administrator or otherwise (e.g., via a suitable interface of device 32). Implementation of functionality within app 32 or otherwise for populating and updating store 44 is within the ken of those skilled in the art in view of the teachings hereof.

In step B, the administrator invokes the artificial intelligence engine 30 to generate a predictive model. In the illustrated embodiment, this is effected via a suitable user interface component of app 32, though, it may be effected by other functionality operating in or in conjunction with that app 32 and/or device 16. As noted above, such invocation can include specifying target and, optionally, candidate predictor variables, as well the data set 40 to be used in connection with model generation—in addition to specifying portions of that (or other) data set(s) to be used in training and test portions of such model generation, as applicable, all per convention in the art as adapted in accord with the teachings hereof.

In step C, the engine 30 utilizes the data set(s) 40 to generate a predictive model, which is returned to the app 32 in step D. Generation of the model is effected utilizing artificial intelligence-based techniques for predictive model generation of the type known in the art as adapted in accord with the teachings hereof. In some embodiments, the engine 30 returns multiple models (sometimes, referred to as “recommendation vectors”), each reflecting a different mix of predictor variables that correlate with the target variable. Return of the model(s) to app 32 is within the ken of those skilled in the art in view of the teachings hereof.

In step E, the app 32 determines whether one or more of the fields identified as a predictor variable in one or more of the returned models (or recommendation vectors) is bias-sensitive. It does this by comparing predictor fields identified in each model with fields identified in the store 44. Such matching of fields in the model with those in the store 44 is within the ken of those skilled in the art in view of the teachings hereof.

In step F, app 32 selectively discards—and, thereby, prevents from being reported to at least some administrators and/or used in targeting marketing or other information at such administrator's direction, e.g., to workstations 18-24—those models identified in step E as including bias-sensitive predictor variables.

In the illustrated embodiment, the app 32 determines whether to so discard such models based on the administrator's authorization, e.g., as reflected by his/her login or other registration rights with the app 32 per convention in the art as adapted in accord with the teachings hereof. Thus, for example, the app 32 does not discard models reported administrators with “full” approval rights; yet, it does do so for models that would otherwise be reported to users with only “partial” rights, all by way of non-limiting example.

Steps F and G (discussed below), where implemented, can help insure that models that include bias-sensitive predictor variables (or other variables that correlate with them, per step G) are not discarded—and that, therefore, can be used in targeting marketing or other information, e.g., to workstations 18-24—if they appear to a suitably authorized administrator to accurately represent the population in the data set 40. For example, the app 32 can report to such administrator a model that reflects a correlation between a likely-to-purchase-womens'-shoes target variable and a bias-sensitive gender predictor variable (e.g., on likelihood that women are mostly likely purchasers of womens' shoes).

As noted above, the predictive models generated by the engine 30 of some embodiments not only identify predictor variables that are correlated (individually or together) with the target variable but also provide a quantitative or qualitative measure of the degree(s) of correlation, either for individual predictor variables and/or the model as a whole. In such embodiments, the app 32 can limit the discarding, in step F, to models (i) in which a bias-sensitive field is identified as a predictor variable, and (ii) for which a correlation reported by the engine 30, either for that variable and/or the model as a whole, is above a certain quantitative or qualitative degree. This is referred to as a “high water mark.” For example, in step F, the system can discard models for which a bias-sensitive predictor variable is at least “moderately” correlated or, in the case of engines 30 that report correlation quantitatively, that are at least 70%, correlated with the target variable—all by way of non-limiting example.

Alternatively, or in addition, in step F for embodiments in which each predictive model generated by engine 30 is generated with a measure of correlation between the overall model and the target variable, the app 32 can reduce that measure for models that predictor variables are identified as bias-sensitive. This can have the effect, for example, of causing such a model to have a lower degree of correlation—as reported to the administrator in step J—then a model that does not include such a bias-sensitive predictor variable.

In step G, the app evaluates any of the remaining models returned in step D to determine whether they identify as predictor variables fields that, although not identified as bias-sensitive in store 44, are highly correlated with those bias-sensitive fields. It does this by invoking the engine 30 to determine the correlation in the data set(s) 40 between each of the predictor variables in those remaining models and the fields identified in store 44. See step H. Invocation of the engine 30 in this manner is within the ken of those skilled in the art in view of the teachings hereof.

In step I, the engine 30 returns measures of correlation for each invocation in step H and, if any of those measures suggests a high correlation (quantitatively, qualitatively or otherwise), the app 32 can add the corresponding predictor variable to the store 44 (or prompt the administrator to do so) and discard any model returned in step D in which it is identified as such (or reduce any correlation reported with it by the engine 30).

Any remaining models are reported by the app to the administrator, along with measures of correlation provided by the engine 30 (as reduced per the discussion above in connection with step F) for each predictor variable and/or for the model as a whole. Those models can be used, as discussed above, to target electronic mail (email), SMS text, web browser banner, as well as web content-based, mailing label-printing or other processors and/or apparatus for purposes sending marketing or other information, in electronic, paper or other forms, e.g., to individuals whose characteristics fall within the scope of predictor variables identified in the models.

Described above are embodiments of digital data systems and methods supporting data retrieval with bias reduction. In some embodiments, these minimize the effect of bias in AI-based business intelligence engines 30 by preventing reporting of models that include (i.e., are “based on”) “bias-sensitive” predictor variables such as race, sex and political affiliation, and so forth. In other embodiments, e.g., where the AI engine 30 returns measures (or degrees) of correlation, such censure can be with respect to models where those measures are above a designated quantitative or qualitative high water mark value. Alternatively, or in addition, the systems and methods hereof can minimize the effect of data bias by reducing such measures of correlation so that the corresponding models appear inferior to ones that are not based on bias-sensitive predictor variables.

It will be appreciated that the embodiments described here and shown in the drawings are merely examples, and that other embodiments fall within the scope of the claims that follow.

1. A method of data retrieval, comprising
accepting a user request,
applying the user request to an artificial intelligence engine to generate a predictive model from a data store that comprises a set of data records, each representing an individual and comprising values for a plurality of fields pertaining to a characteristic of that individual, the predictive model identifying one or more of the fields as predictor variables that are correlated with a field that is a target variable,
determining whether one or more of the fields identified as a predictor variable is bias-sensitive.

2. The method of claim 1 comprising preventing from being reported to the user a model for which one or more fields identified as a predictor variable is bias-sensitive.

3. The method of claim 1, comprising preventing from being reported to the user a model for which (i) a bias-sensitive field is identified as a predictor variable and (ii) a measure of correlation generated by the artificial intelligence engine is above a high water mark value.

4. The method of claim 3, comprising reducing a measure of correlation generated by the artificial intelligence engine for a model for which a bias-sensitive field is identified as a predictor variable.

5. The method of claim 4, comprising reporting the model to the user with the reduced measure of correlation.

6. The method of claim 4, comprising reducing the measure of correlation generated by the artificial intelligence engine for the model for which a bias-sensitive field is identified as a predictor variable so that measure of correlation falls below that of another model generated by the artificial intelligence engine.

7. The method of claim 1, comprising accepting as input an identification of one or more fields that are bias-sensitive.

8. The method of claim 7, comprising identifying additional bias-sensitive fields by using the artificial intelligence engine to identify in the data set fields that are highly correlated with those identified via input as bias-sensitive.

9. A machine readable storage medium having stored thereon a computer program configured to cause a digital data device to perform the steps of:
accepting a user request,
applying the user request to an artificial intelligence engine to generate a predictive model from a data store that comprises a set of data records, each representing an individual and comprising values for a plurality of fields pertaining to a characteristic of that individual, the predictive model identifying one or more of the fields as predictor variables that are correlated with a field that is a target variable,
determining whether one or more of the fields identified as a predictor variable is bias-sensitive.

10. The machine readable storage medium of claim 9 having stored thereon a computer program for causing the digital data device to perform the step of preventing from being reported to the user a model for which one or more fields identified as a predictor variable is bias-sensitive.

11. The machine readable storage medium of claim 9 having stored thereon a computer program for causing the digital data device to perform the step of preventing from being reported to the user a model for which (i) a bias-sensitive field is identified as a predictor variable and (ii) a measure of correlation generated by the artificial intelligence engine is above a high water mark value.

12. The machine readable storage medium of claim 11 having stored thereon a computer program for causing the digital data device to perform the step of reducing a measure of correlation generated by the artificial intelligence engine for a model for which a bias-sensitive field is identified as a predictor variable.

13. The machine readable storage medium of claim 12 having stored thereon a computer program for causing the digital data device to perform the step of reporting the model to the user with the reduced measure of correlation.

14. The machine readable storage medium of claim 9 having stored thereon a computer program for causing the digital data device to perform the step of reducing the measure of correlation generated by the artificial intelligence engine for the model for which a bias-sensitive field is identified as a predictor variable so that measure of correlation falls below that of another model generated by the artificial intelligence engine.

15. The machine readable storage medium of claim 9 having stored thereon a computer program for causing the digital data device to perform the step of accepting as input an identification of one or more fields that are bias-sensitive.

16. The machine readable storage medium of claim 15 having stored thereon a computer program for causing the digital data device to perform the step of identifying additional bias-sensitive fields by using the artificial intelligence engine to identify in the data set fields that are highly correlated with those identified via input as bias-sensitive.

17. Computer instructions configured to cause a digital data device to perform the steps of:
accepting a user request,
applying the user request to an artificial intelligence engine to generate a predictive model from a data store that comprises a set of data records, each representing an individual and comprising values for a plurality of fields pertaining to a characteristic of that individual, the predictive model identifying one or more of the fields as predictor variables that are correlated with a field that is a target variable,
determining whether one or more of the fields identified as a predictor variable is bias-sensitive.

18. The computer instructions of claim 17 configured to cause a digital data device to perform the step of preventing from being reported to the user a model for which one or more fields identified as a predictor variable is bias-sensitive.

19. The computer instructions of claim 18 configured to cause the digital data device to perform the step of preventing from being reported to the user a model for which (i) a bias-sensitive field is identified as a predictor variable and (ii) a measure of correlation generated by the artificial intelligence engine is above a high water mark value.

20. The computer instructions of claim 19 configured to cause the digital data device to perform the step of reducing a measure of correlation generated by the artificial intelligence engine for a model for which a bias-sensitive field is identified as a predictor variable.
